(19) United States
(12) Patent Application Publication
(10) Pub. No.: US 2022/0022713 A1
(43) Pub. Date: Jan. 27, 2022

(54) VACUUM CLEANER SYSTEM AND DANGEROUS POSITION POSTING METHOD

(71) Applicant: Panasonic Intellectual Property Management Co., Ltd., Osaka (JP)

(72) Inventors: Renji Honda, Nara (JP); Yuko Tsusaka, Kyoto (JP)

(21) Appl. No.: 17/378,427

(22) Filed: Jul. 16, 2021

(30) Foreign Application Priority Data
Jul. 22, 2020 (JP) 2020-125097

(51) Int. Cl. A47L 9/28; G08B 5/22; G08B 21/02; A47L 9/00

(52) U.S. Cl. CPC A47L 9/2857; G08B 5/22; G08B 21/02; A47L 2201/04; A47L 9/2852; A47L 9/009; A47L 9/2826

(57) ABSTRACT

A vacuum cleaner system includes a vacuum cleaner that performs cleaning while autonomously running and a display unit that displays information acquired from the vacuum cleaner. The vacuum cleaner system includes: an object information acquisition unit that acquires object information, which is information on an object present around the vacuum cleaner, based on a first sensor, a danger determination unit that determines danger of the object based on the acquired object information, a map acquisition unit that acquires a map of an area where the vacuum cleaner runs; and a dangerous position display unit that causes the display unit to display the danger of the object determined by the danger determination unit and the acquired position of the object on the map in association with each other.

### BACKGROUND

### 1. Technical Field

The present disclosure relates to a vacuum cleaner system including a vacuum cleaner that autonomously runs to perform cleaning and a display unit and a dangerous position posting method for posting a dangerous position using a vacuum cleaner system.

### 2. Description of the Related Art

JP 2019-76658 A (to be referred to as “Patent Literature 1” hereinafter) discloses an autonomous vacuum cleaner, a so-called robot vacuum cleaner. The robot vacuum cleaner can search for an expandable cleaning area, present a new cleaning area to the user, and adopt the new cleaning area.

Further, the robot vacuum cleaner has a function of detecting a change in a map from the difference between a result of previous cleaning and a result of current cleaning and displaying a user confirmation confirming to the user whether or not the map is adopted as a new cleaning area. As a result, the user can prevent a place that the user does not want the robot vacuum cleaner to enter unintentionally from being cleaned, and when adding a new area to the cleaning area, the user can explicitly instruct the robot vacuum cleaner.

### SUMMARY

The present disclosure provides a vacuum cleaner system that detects the position of a dangerous object when the vacuum cleaner runs and posts the position in a map and a method of posting the position of a dangerous object.

The present disclosure is a vacuum cleaner system including a vacuum cleaner that performs cleaning while autonomously running and a display unit that displays information acquired from the vacuum cleaner. The vacuum cleaner system includes an object information acquisition unit that acquires object information, which is information on an object present around the vacuum cleaner, based on a sensor included in the vacuum cleaner, a danger determination unit that determines danger of the object based on the acquired object information, a map acquisition unit that acquires a map of an area where the vacuum cleaner runs, and a dangerous position display unit that displays the danger of the object determined by the danger determination unit and the acquired position of the object on the map on a display unit in association with each other.

The present disclosure is a dangerous position posting method for a vacuum cleaner system including a vacuum cleaner that performs cleaning while autonomously running and a display unit that displays information acquired from the vacuum cleaner. In this dangerous position posting method, an object information acquisition unit acquires object information, which is information on an object present around the vacuum cleaner, from the vacuum cleaner, a danger determination unit determines danger of the object based on the acquired object information, a map acquisition unit acquires a map of an area where the vacuum cleaner runs, and a dangerous position display unit displays the danger of the object determined by the danger determination unit and the acquired position of the object on the map on a display unit in association with each other.

According to the present disclosure, it is possible to provide a vacuum cleaner system and a dangerous position posting method that can post the position of a dangerous object.

### BRIEF DESCRIPTION OF THE DRAWINGS

FIG. 1 is a block diagram illustrating a configuration of a vacuum cleaner system according to an exemplary embodiment;

FIG. 2 is a diagram illustrating an example of a map created by a creation recognition unit according to the exemplary embodiment;

FIG. 3 is a diagram illustrating an example of a movement of the vacuum cleaner during information acquisition running according to the exemplary embodiment;

FIG. 4 is a diagram illustrating an example of danger management information according to the exemplary embodiment;

FIG. 5 is a diagram illustrating an example of a floor map including a cleaning target area of the vacuum cleaner according to the exemplary embodiment;

FIG. 6 is a diagram illustrating an example of information displayed on a display unit according to the exemplary embodiment;

FIG. 7 is a flowchart illustrating a procedure of processing in the vacuum cleaner system when the vacuum cleaner according to the exemplary embodiment performs information acquisition running in the middle of normal cleaning running;

FIG. 8 is a schematic view illustrating a state in which the running vacuum cleaner according to the exemplary embodiment approaches a descending step;

FIG. 9 is a schematic view illustrating a state in which the running vacuum cleaner according to the exemplary embodiment approaches an ascending step having a relatively low height;

FIG. 10 is a schematic diagram illustrating a state in which the running vacuum cleaner according to the exemplary embodiment approaches an object on a floor surface;

FIG. 11 is a schematic diagram illustrating a state in which the running vacuum cleaner according to the exemplary embodiment rides on an object on a floor surface;

FIG. 12 is a schematic diagram illustrating a state in which the running vacuum cleaner according to the exemplary embodiment approaches a string-like object on a floor surface;

FIG. 13 is a block diagram illustrating a configuration of another example 1 of the vacuum cleaner system;

FIG. 14 is a block diagram illustrating a configuration of another example 2 of the vacuum cleaner system; and

FIG. 15 is a diagram illustrating an example of an object that is not determined to be dangerous.

### DETAILED DESCRIPTION

Hereinafter, an embodiment of a vacuum cleaner system and a dangerous position posting method according to the present disclosure will be described with reference to the drawings. Numerical values, shapes, materials, components, the positional relationship between constituent elements, connection states of the constituent elements, steps, the orders of steps, and the like, to be used in the following exemplary embodiments are exemplary and are not to limit the scope of the present disclosure. Further, in the following, a plurality of inventions may be described as one embodiment, but constituent elements not described in the claims are described as arbitrary constituent elements in the invention according to the claims. In addition, the drawings are schematic views in which emphasis, omission, and ratio adjustment are appropriately performed in order to describe the present disclosure, and may be different from actual shapes, positional relationships, and ratios.

In addition, a description more detailed than necessary may be omitted. For example, the detailed description of already well-known matters or the overlap description of substantially same configurations may be omitted. This is to avoid an unnecessarily redundant description below and to facilitate understanding of a person skilled in the art.

Note that the attached drawings and the following description are provided for those skilled in the art to fully understand the present disclosure, and are not intended to limit the subject matter as described in the appended claims.

### Exemplary Embodiment

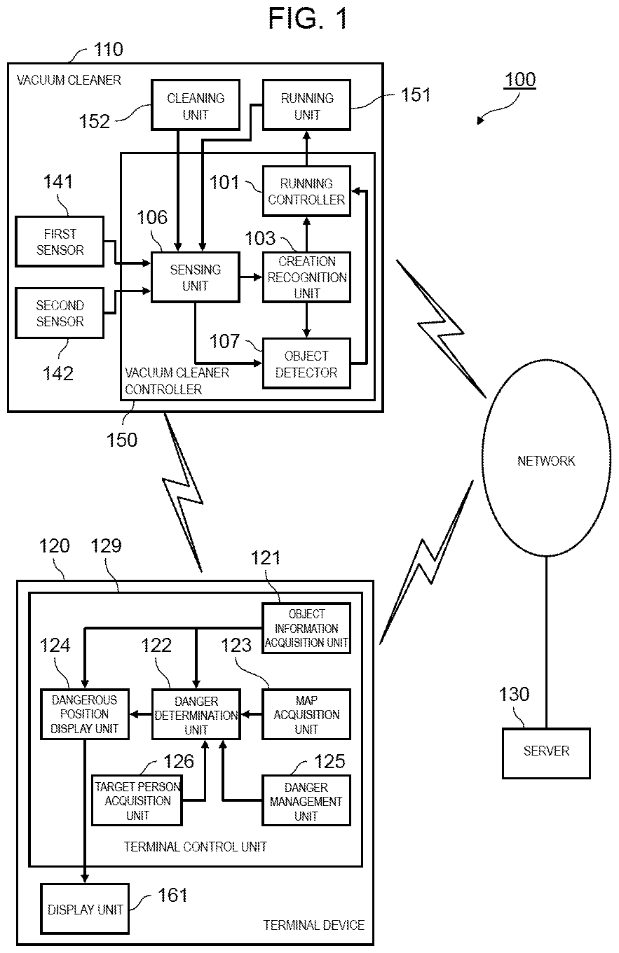

Hereinafter, a vacuum cleaner system and a dangerous position posting method according to an exemplary embodiment of the present disclosure will be described with reference to FIGS. 1 to 6.

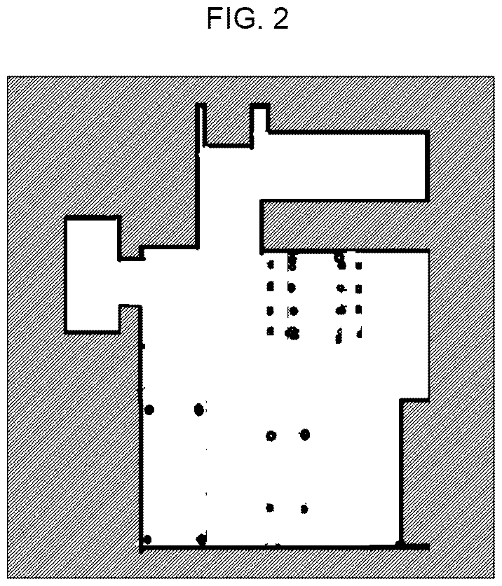

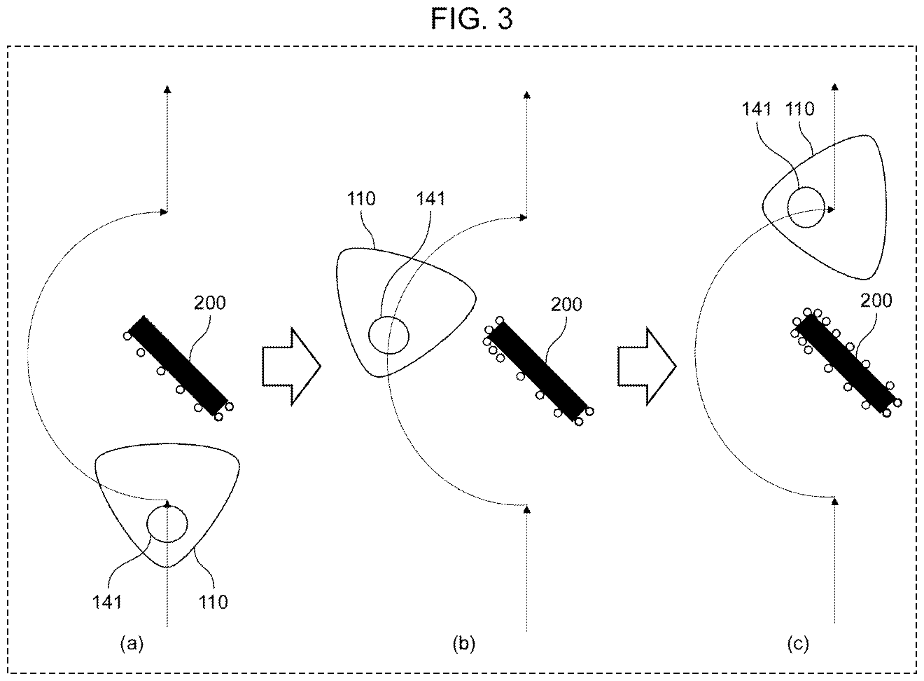

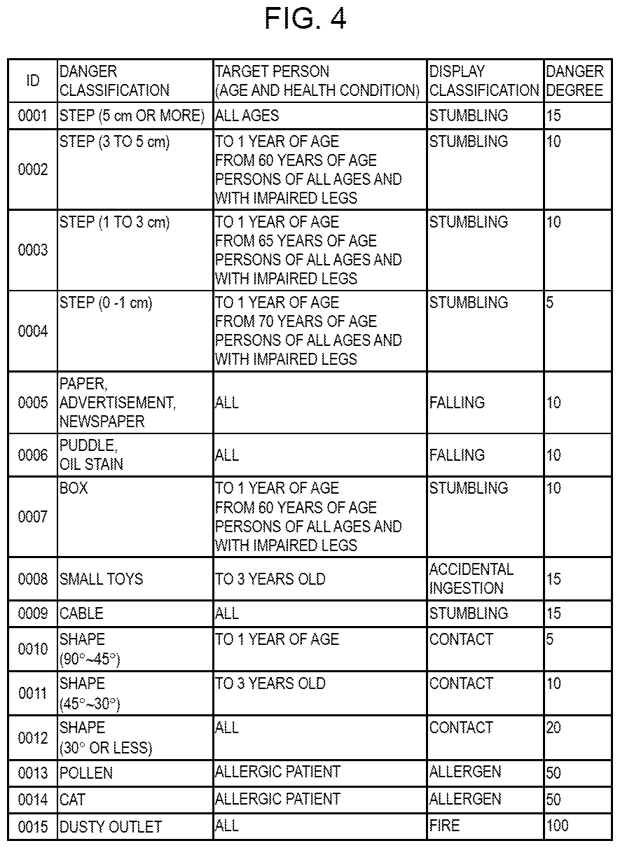

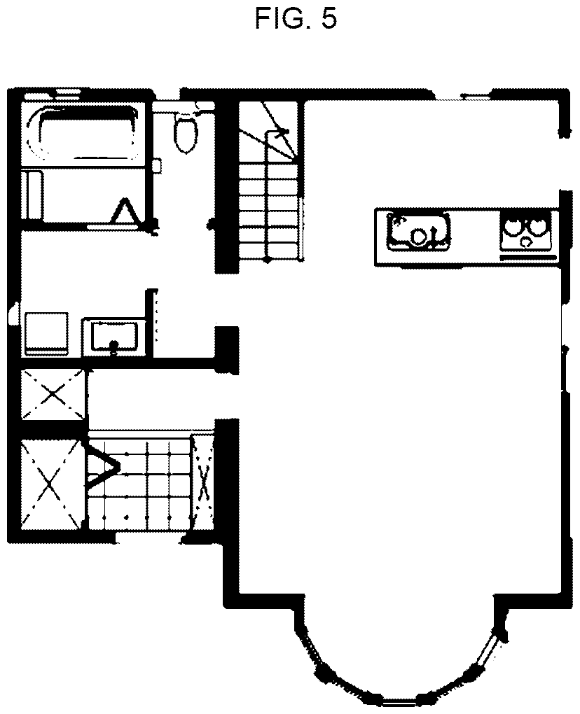

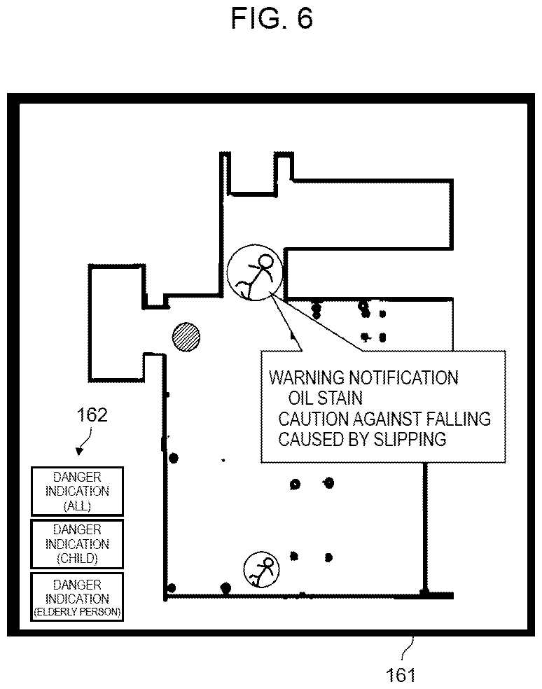

FIG. 1 is a block diagram illustrating a configuration of vacuum cleaner system 100 according to the exemplary embodiment. FIG. 2 is a diagram illustrating an example of a map created by creation recognition unit 103 according to the exemplary embodiment. FIG. 3 is a diagram illustrating an example of a movement of vacuum cleaner 110 during information acquisition running according to the exemplary embodiment. FIG. 4 is a diagram illustrating an example of danger management information according to the exemplary embodiment. FIG. 5 is a diagram illustrating an example of a floor map including a cleaning target area of vacuum cleaner 110 according to the exemplary embodiment. FIG. 6 is a diagram illustrating an example of information displayed on display unit 161 according to the exemplary embodiment.

As illustrated in FIG. 1, vacuum cleaner system 100 includes vacuum cleaner 110 that autonomously runs and cleans and terminal device 120 including display unit 161 that displays information acquired from vacuum cleaner 110. In vacuum cleaner system 100, vacuum cleaner 110 and terminal device 120 can perform information communication with server 130 via a network. Vacuum cleaner 110 and terminal device 120 may directly communicate with each other without going through a network.

Vacuum cleaner 110 is a vacuum cleaner that includes a communication device (not illustrated) and a sensor and autonomously runs based on information from the sensor. Note that vacuum cleaner 110 only needs to be an autonomous running vacuum cleaner including a communication device and a sensor, and other functions are not particularly limited. Vacuum cleaner 110 includes sensors that acquire various types of information for autonomous running and cleaning. The sensor included in vacuum cleaner 110 is not particularly limited, and for example, an ultrasonic sensor, a light detection and ranging (LiDAR) sensor, an RGB camera, a DEPTH camera, an infrared distance measuring sensor, a wheel odometry, a gyro sensor, and the like can be exemplified as sensors included in vacuum cleaner 110. Further, vacuum cleaner 110 may include a sensor that acquires the rotation state of a brush used for cleaning and a sensor that acquires the contamination state of a floor surface.

In the present exemplary embodiment, vacuum cleaner 110 includes at least first sensor 141 of a predetermined type and second sensor 142 of a type different from that of the first sensor. In addition, vacuum cleaner 110 includes running unit 151, cleaning unit 152, and vacuum cleaner controller 150 that implements the operation of each processing unit by executing a program.

Vacuum cleaner controller 150 is a so-called computer including a storage unit (not illustrated) and a calculator (not illustrated), and executes programs to implement sensing unit 106, creation recognition unit 103, object detector 107, and running controller 101.

Sensing unit 106 acquires signals from at least first sensor 141 and second sensor 142, and outputs object information corresponding to the acquired signals to each processing unit. In addition, sensing unit 106 acquires information regarding the rotation angle of a motor included in at least one of running unit 151 and cleaning unit 152, information regarding the rotation state of the motor, and the like. In the present exemplary embodiment, sensing unit 106 generates first object information that is one piece of object information based on the information acquired from first sensor 141 and outputs the generated first object information. In addition, sensing unit 106 generates second object information of a type different from a type of the first object information on the basis of the information acquired from second sensor 142 and outputs the generated second object information. Note that vacuum cleaner 110 may further include other sensors such as a third sensor and a fourth sensor. When vacuum cleaner 110 further includes other sensors such as the third sensor and the fourth sensor, sensing unit 106 may further generate the third object information, the fourth object information, and the like on the basis of the information acquired from each of the sensors and output the generated information.

Creation recognition unit 103 creates a map regarding the surrounding environment of vacuum cleaner 110 by, for example, the simultaneous localization and mapping (SLAM) technology on the basis of the information acquired from sensing unit 106 and outputs information indicating the map. Creation recognition unit 103 creates a map as illustrated in FIG. 2, for example, during a period from when vacuum cleaner 110 starts operation to when a series of cleaning ends and stops. Note that a set of black island-shaped points illustrated in the map of FIG. 2 indicates, for example, a table, a leg of a chair, or the like arranged on a floor. Furthermore, creation recognition unit 103 recognizes its own position (to be also referred to as self-position hereinafter) on the created map and outputs information indicating its own position. Specifically, creation recognition unit 103 sequentially updates the map using sensing information of LiDAR which is one of the sensors included in vacuum cleaner 110, wheel odometry which is another sensor, a gyro sensor which is still another sensor, and the like. In addition, creation recognition unit 103 can sequentially confirm the self-position of vacuum cleaner 110. In addition, creation recognition unit 103 can create a map using an RGB camera instead of LiDAR and recognize the self-position of vacuum cleaner 110.

Object detector 107 detects an object that obstructs autonomous running by using the information acquired from sensing unit 106 and the information indicating the self-position of vacuum cleaner 110 acquired from creation recognition unit 103. The object detector 107 can output object information including the position of an object on the map acquired from the creation recognition unit 103. Note that the details of object information will be described later.

In the present exemplary embodiment, object detector 107 causes running controller 101 to execute information acquisition running in order to acquire object information. The object information is information indicating the outer peripheral shape of a cross section of the object parallel to the floor surface. Information acquisition running is, for example, as illustrated in parts (a), (b), and (c) of FIG. 3, the running of vacuum cleaner 110 that runs along a running route which is different from that during normal cleaning and in which the outer peripheral shape of an object is easily acquired. Note that specific information acquisition running using FIG. 3 will be described later.

Based on the information representing the map obtained from creation recognition unit 103 and the information representing the self-position of vacuum cleaner 110, running controller 101 controls running unit 151 to cause vacuum cleaner 110 to run exhaustively while avoiding an object in an area surrounded by a wall surface or the like on the map.

Running unit 151 includes wheels and a motor for causing vacuum cleaner 110 to run. Further, an encoder that functions as a wheel odometry sensor and acquires the rotation angle of the motor may be attached to running unit 151.

Cleaning unit 152 is controlled by a cleaning controller (not illustrated) to perform cleaning. The type of cleaning unit 152 is not particularly limited. For example, when vacuum cleaner 110 is configured to perform suction-type cleaning, cleaning unit 152 includes a suction motor for suction, a side brush that rotates on a side of a suction port to collect dust, and a brush motor that rotates the side brush. When vacuum cleaner 110 is configured to perform wiping-type cleaning, cleaning unit 152 includes a cloth or mop for wiping and a wiping motor for operating the cloth or mop. Note that cleaning unit 152 may be configured to implement both suction-type cleaning and wiping-type cleaning.

Terminal device 120 includes a communication device (not illustrated) that acquires information from vacuum cleaner 110, and processes the information acquired by the communication device. Terminal device 120 includes display unit 161 that can display the processed information to the user and terminal controller 129. As terminal device 120, for example, a so-called smartphone, a so-called tablet, a so-called notebook personal computer, a so-called desktop personal computer, or the like can be exemplified. Terminal device 120 includes object information acquisition unit 121, danger determination unit 122, map acquisition unit 123, dangerous position display unit 124, danger management unit 125, and target person acquisition unit 126 as processing units implemented by executing programs in a processor (not illustrated) included in terminal controller 129. In the present exemplary embodiment, terminal device 120 is a terminal that can be carried by a target person. Note that, in the present disclosure, a person who is a target indicating danger at a dangerous spot is referred to as a target person. Target persons are divided into several groups according to age, health condition, and the like. For example, if a target person is a healthy adult, it is less necessary to indicate a small step with low danger degree for a healthy adult as a dangerous spot to the target person. However, even such a small step is a dangerous spot with a high degree of danger for infants, elderly people, and people with injuries or disabilities in the legs or eyes. Therefore, when a target person is an infant, elderly person, or person having an injury or disability in the feet or eyes, it is desirable to indicate a small step as a dangerous spot with high danger degree. On the other hand, since a large step is a dangerous spot with high danger degree for normal adults, it is desirable to indicate the large step as a dangerous spot for target persons of all ages. For this reason, target persons are divided into, for example, infants, children, elderly persons, allergic patients, persons with leg disability, and the like. Alternatively, target persons may be divided according to ages, such as 1 year old or younger, 3 years old or younger, 60 years old or older, 70 years old or older, and all ages.

Object information acquisition unit 121 acquires, from object detector 107 of vacuum cleaner 110, object information that is information on an object present around vacuum cleaner 110. Object information acquisition unit 121 may directly acquire object information from vacuum cleaner 110 or may acquire object information via a network.

Danger management unit 125 acquires danger management information in which the type of danger of a detected object, a danger degree indicating the degree of danger, and object information are associated with each other. In the present exemplary embodiment, danger management unit 125 acquires the danger management information illustrated in FIG. 4 and outputs the danger management information to danger determination unit 122. In the present exemplary embodiment, danger management unit 125 can acquire danger management information from server 130 via a network and store the acquired information in a storage device (not illustrated). Danger management unit 125 can also reacquire and update danger management information.

Note that danger management information includes target person information indicating information regarding a target person who uses terminal device 120. Target person information includes, for example, the age of the user of terminal device 120, the health condition of the user, such as the presence or absence of an injury, the presence or absence of a disorder, the presence or absence of an allergy, and the type of allergen type, and the like. Danger management information is stored in a storage device (not illustrated) as a table in which the type of the target person, a danger classification which is object information, a display classification, a danger degree, and the like are associated with each other.

Danger determination unit 122 determines the danger of the object based on the object information acquired by object information acquisition unit 121. Danger determination unit 122 may determine the danger of an object by referring to the danger management information managed by danger management unit 125. In the present exemplary embodiment, danger determination unit 122 determines the danger of an object on the basis of a plurality of mutually different types of object information such as first object information and second object information output by sensing unit 106. Note that a specific method of determining danger will be described later.

Map acquisition unit 123 acquires a map of an area where vacuum cleaner 110 runs. The type of the map acquired by map acquisition unit 123 and the acquisition destination of the map are not particularly limited. For example, map acquisition unit 123 may acquire a map (illustrated in FIG. 2) created by creation recognition unit 103 of vacuum cleaner 110 using SLAM or the like by communication. In this case, the position of the object that is part of the object information may be indicated in the map. Further, map acquisition unit 123 may acquire a floor map of a floor including a cleaning target area of vacuum cleaner 110 as illustrated in FIG. 5 as a map from server 130 via a network. In addition, map acquisition unit 123 may acquire the map created by a map creation unit (not illustrated) included in terminal device 120. Note that map acquisition unit 123 may acquire a plurality of maps or may combine a plurality of maps into one map. Note that a map in this case is information or data representing a map that can be processed by the processor, and a map as a visually recognizable graphic created on the basis of this information or data is displayed on display unit 161. In the present exemplary embodiment, information or data representing a map that can be processed by the processor and a map as a visually recognizable graphic are not particularly distinguished and are both expressed as maps.

Dangerous position display unit 124 causes display unit 161 to display the danger of the object determined by danger determination unit 122 and the position of the object on the map acquired from object detector 107 of vacuum cleaner 110 in association with each other. As illustrated in FIG. 6, dangerous position display unit 124 causes display unit 161 to display a danger information map including a dangerous spot and the type of danger in the map. In addition, dangerous position display unit 124 may indicate danger information suitable for a target person on a danger information map using an icon, an illustration, a text, or the like on the basis of the danger management information obtained from danger management unit 125 and cause display unit 161 to display the resultant information.

Note that the map displayed on display unit 161 is desirably configured to be able to be enlarged and reduced. Furthermore, in a case where the self-position of terminal device 120 can be acquired with high accuracy, a map of the periphery of the position where the target person holding terminal device 120 stays and dangerous spots may be displayed on display unit 161 in association with a real space. Display unit 161 may be controlled such that detailed information of the dangerous spot is displayed when the icon displayed on display unit 161 is tapped.

As for an icon, the manner of displaying the icon may be changed according to the degree of danger of the dangerous spot or the distance from the target person holding terminal device 120 to the dangerous spot. For example, the size of the icon to be displayed may be changed according to the danger degree for the target person holding terminal device 120 such that the size of the icon is relatively increased for a dangerous spot having a high danger degree for the target person holding terminal device 120 and the size of the icon is relatively reduced for a dangerous spot having a low danger degree for the subject. Furthermore, the distance from the target person holding terminal device 120 to the dangerous spot may be calculated, and when the calculated value is less than or equal to a predetermined distance, a display for calling attention to the target person may be popped up on display unit 161. Furthermore, not only an icon may be displayed on display unit 161, but also a warning sound may be generated using a speaker included in terminal device 120 or terminal device 120 may be vibrated to notify a target person holding terminal device 120 that the target person is approaching a dangerous spot when the target person approaches the dangerous spot.

For example, as illustrated in FIG. 6, target person acquisition unit 126 may display options representing a plurality of types of target persons on display unit 161 using graphical user interface (GUI) 162 or the like. When the target person holding terminal device 120 selects one of the options indicated by GUI 162, target person acquisition unit 126 may acquire the information of the corresponding target person.

Furthermore, target person acquisition unit 126 may acquire the voice of the target person using a microphone or the like included in terminal device 120 and estimate the information of the target person by the acquired voice. For example, when the voice of a child is acquired, target person acquisition unit 126 may estimate that the child is acting around terminal device 120. In addition, for example, when the voice of an elderly is acquired, target person acquisition unit 126 may estimate that the elderly is around terminal device 120. Furthermore, when the voice of an animal considered to be a pet is acquired, target person acquisition unit 126 may estimate that there is a pet around terminal device 120.

When terminal device 120 has a function of managing schedules, terminal device 120 may estimate the information of the target person from the contents of a schedule.

Danger determination unit 122 may determine danger based on the target person information acquired by target person acquisition unit 126. In addition, dangerous position display unit 124 may cause display unit 161 to display the danger of an object and the position on the map where the object information of the object has been acquired in association with each other according to the type of target person on the basis of the information of the target person acquired by target person acquisition unit 126.

Server 130 can communicate with vacuum cleaner 110 and terminal device 120 via a network to transmit and receive information. In the present exemplary embodiment, server 130 can communicate with each of the plurality of vacuum cleaners 110 and the plurality of terminal devices 120, and can acquire object information from the plurality of vacuum cleaners 110. Furthermore, server 130 may acquire, for example, information indicating the relationship between object information and an accident that has occurred to a person. In this manner, server 130 additionally creates or updates the danger management information based on a plurality of pieces of information including the object information acquired from a plurality of or single vacuum cleaner 110. Furthermore, server 130 may collect and manage floor maps of residences, apartments, hotels, tenants, and the like.

### Specific Example 1

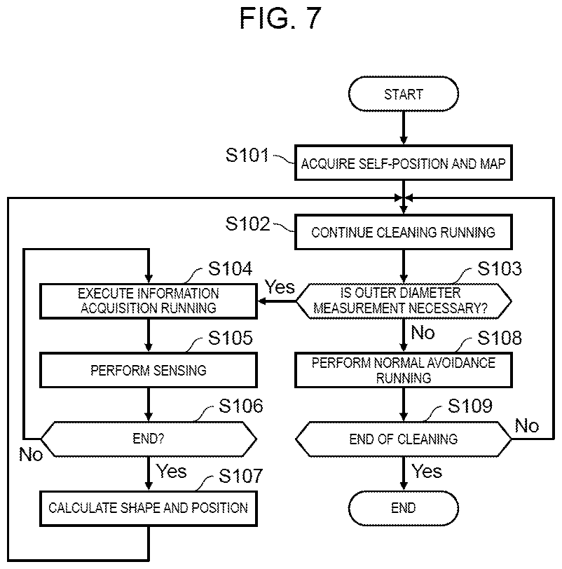

Specific example 1 of generation of object information and determination by danger determination unit 122 based on the object information will be described next with reference to FIGS. 7 and 3.

FIG. 7 is a flowchart illustrating the procedure of processing in vacuum cleaner system 100 when vacuum cleaner 110 according to the present exemplary embodiment performs information acquisition running in the middle of normal cleaning running. Note that the flowchart shown in FIG. 7 and the description of the following procedure show an example of processing of vacuum cleaner system 100 in the present exemplary embodiment, and the order of steps may be changed, another step may be added, or some steps may be deleted.

Running controller 101 acquires the self-position of vacuum cleaner 110 from sensing unit 106, and receives, for example, information representing the map created by SLAM from creation recognition unit 103 (S101). Next, running controller 101 starts cleaning running of vacuum cleaner 110 (S102). Object detector 107 detects the presence or absence of an object that obstructs the running of vacuum cleaner 110 during the cleaning running. Upon detecting an object that hinders vacuum cleaner 110 from running, object detector 107 determines whether or not information acquisition running for the detected object is necessary (S103). In step S103, object detector 107 determines whether or not the detected object is an undetected object in the previous cleaning running or the like. Upon determining that the detected object is an undetected object, object detector 107 determines that it is necessary to measure the outer diameter of the object and to perform information acquisition running (S103: Yes).

Upon determining in step S103 that it is necessary to measure the outer diameter of the object (S103: Yes), object detector 107 controls running controller 101 to execute information acquisition running (S104). Information acquisition running is a state in which object detector 107 controls running controller 101 to cause vacuum cleaner 110 to run so as to effectively acquire the outer shape of an object using a sensor included in vacuum cleaner 110. In the information acquisition running, for example, as illustrated in FIG. 3, object detector 107 causes vacuum cleaner 110 to run a distance of at least about a half turn or more around object 200 so as to keep the distance between object 200 and vacuum cleaner 110 constant. During the information acquisition running, sensing unit 106 of vacuum cleaner 110 senses the outer peripheral shape of object 200 based on sensors such as first sensor 141 and second sensor 142 (S105). Object detector 107 determines whether or not running on a predetermined route in the information acquisition running has ended (S106). Upon determining in step S106 that the running is not ended (S106: No), object detector 107 returns to step S104 and re-executes the processing in steps S104 to S106. Upon determining that the processing has ended (S106: Yes), object detector 107 generates and holds the outer peripheral shape of object 200, the posture with respect to the map, the coordinates, and the like as object information. Referring to FIG. 3, white circles around object 200 indicate measurement points sensed by LiDAR which vacuum cleaner 110 includes as first sensor 141 in Specific Example 1.

A specific example of a method of acquiring the outer peripheral shape of object 200 will be described here with reference to FIG. 3. FIG. 3 schematically illustrates how vacuum cleaner 110 performs information acquisition running while avoiding object 200 after detecting object 200 present in front of vacuum cleaner 110 in the running direction. Referring to FIG. 3, the time course of information acquisition running by vacuum cleaner 110 is illustrated in the order of (a), (b), and (c), and the running route of vacuum cleaner 110 is indicated by the solid arrows. At the position of vacuum cleaner 110 illustrated in part (a) of FIG. 3 or in the vicinity of the position, vacuum cleaner 110 can measure a surface of object 200 which is located on the vacuum cleaner 110 side to obtain measurement points on the surface. These measurement points are indicated by the white circles in the drawing. In Specific Example 1, the measurement points are obtained based on LiDAR. When vacuum cleaner 110 continues the information acquisition running and moves to the position illustrated in part (b) of FIG. 3, the side surface of object 200 hidden when viewed from vacuum cleaner 110 at the position illustrated in part (a) of FIG. 3 can be measured. By performing measurement on the surface, measurement points on the surface are acquired as additional information by vacuum cleaner 110. Further, vacuum cleaner 110 continues the information acquisition running so as to go around object 200 while maintaining the constant distance from object 200, whereby vacuum cleaner 110 reaches the position illustrated in part (c) of FIG. 3. As a result, it is possible to measure the back surface of object 200 hidden when viewed from vacuum cleaner 110 at the position illustrated in part (a) of FIG. 3, that is, the surface opposite to the surface from which the measurement points are obtained in part (a) of FIG. 3. Measurement is also performed on the surface, and measurement points on the surface are acquired as additional information by vacuum cleaner 110.

The continuation of the flowchart will be described by referring back to FIG. 7. Upon determining in step S106 that the information acquisition running has ended (S106: Yes), object detector 107 calculates the outer peripheral shape of the object and the position on the map as object information based on the held measurement points (S107). Specifically, for a plurality of measurement points indicating the shape of the object acquired and held in step S105, object detector 107 calculates a plurality of straight lines by calculating a straight line connecting the coordinates of two measurement points for each adjacent measurement point. In this way, based on the self-position of vacuum cleaner 110 during the information acquisition running and the relative positional relationship between vacuum cleaner 110 and the measurement points, object detector 107 acquires the outer peripheral shape of a cross section of the object, for which it is determined in step S103 that outer diameter measurement is necessary, which is parallel to the floor surface, and generates object information.

On the other hand, in step S103, if object detector 107 determines that it is unnecessary to measure the outer diameter of the detected object (S103: No), running controller 101 executes normal avoidance running, that is, run to avoid an object that hinders running during cleaning running (S108). Running controller 101 determines whether or not the cleaning is finished (S109). If it is determined that the cleaning is not finished (S109: No), the process returns to step S102. Each step after step S102 is executed again. The series of processes described above is executed until the end of cleaning. After it is determined in step S109 that the cleaning has ended (S109: Yes), running controller 101 ends the cleaning running.

When object information acquisition unit 121 of terminal device 120 acquires object information including the outer diameter shape of the object, danger determination unit 122 calculates the angle of the straight line calculated by object detector 107 with respect to the wall surface on the map, and compares the angle with a predetermined threshold value. If the angle is less than or equal to the threshold value, danger determination unit 122 determines that the object has a sharp convex shape and is dangerous. Furthermore, danger determination unit 122 may calculate a danger degree according to the angle.

In this manner, vacuum cleaner system 100 can detect an object having a sharp shape present in the cleaning area of vacuum cleaner 110 using LiDAR functioning as first sensor 141, and can determine the detected object as a dangerous object present in the cleaning area of vacuum cleaner 110. Dangerous position display unit 124 can display information on an object having such a sharp shape on display unit 161 to specifically present a dangerous point to the target person.

### Specific Example 2

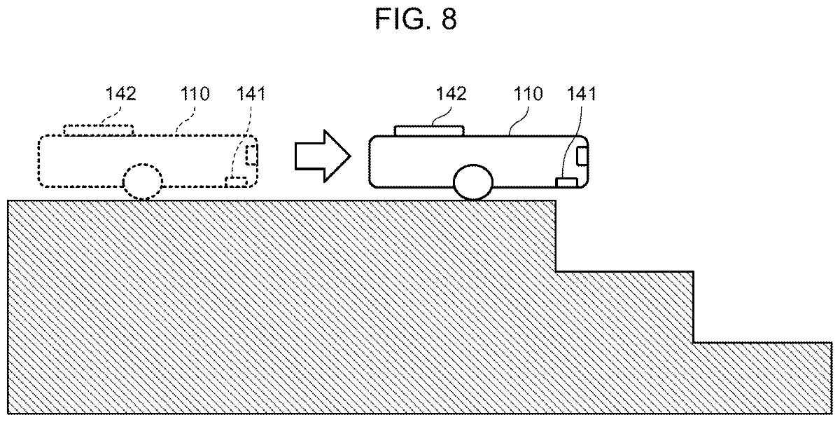

Specific example 2 of generation of object information and determination by danger determination unit 122 based on the object information will be described next with reference to FIG. 8. FIG. 8 is a schematic view illustrating a state in which running vacuum cleaner 110 according to the exemplary embodiment approaches a descending step.

In specific example 2, as shown in FIG. 8, vacuum cleaner 110 includes a downward distance measuring sensor as first sensor 141 on the lower surface of the main body of vacuum cleaner 110. The downward distance measuring sensor is a sensor that measures the distance from the lower surface of vacuum cleaner 110 to the floor surface. Note that the type of downward distance measuring sensor is not particularly limited, and an infrared distance measuring sensor, a time of flight (TOF) sensor, or the like can be exemplified as the downward distance measuring sensor. When vacuum cleaner 110 moves forward based on a running instruction from running controller 101 and approaches a downward step, first sensor 141 functioning as a downward distance measuring sensor detects the space to the downward step and outputs information indicating a distance value larger than usual. Object detector 107 compares the distance measurement value of first sensor 141 input from sensing unit 106 with a predetermined threshold value. When the distance measurement value is larger than or equal to the threshold, object detector 107 determines that there is a downward step where vacuum cleaner 110 may fall, and instructs running controller 101 to stop forward movement of vacuum cleaner 110. In addition, object detector 107 outputs the descending step as object information together with the coordinates of the edge portion of the descending step. In Specific Example 2, object detector 107 recognizes the descending step as an obstacle to running of vacuum cleaner 110. Danger determination unit 122 determines that the position is a dangerous position on the basis of the object information including the position of the descending step acquired from object detector 107.

In order to change the presentation method in accordance with the physical ability of a target person, object detector 107 may include the depth (distance) of a descending step in object information. Danger determination unit 122 may determine danger degree in accordance with the depth of the descending step included in the object information. In addition, object detector 107 may output the position of the edge of the descending step as coordinates offset to the front side in the running direction of vacuum cleaner 110 with respect to the position acquired by sensing unit 106 as the self-position of vacuum cleaner 110. Note that object detector 107 may set this offset amount on the basis of the distance between the position determined as the self-position of vacuum cleaner 110 and the attachment position of the downward distance measuring sensor which is first sensor 141 in the running direction of vacuum cleaner 110.

### Specific Example 3

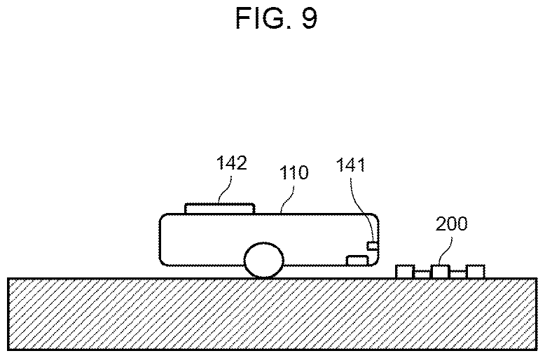

Specific example 3 of generation of object information and determination by danger determination unit 122 based on the object information will be described next with reference to FIG. 9. FIG. 9 is a schematic view illustrating a state in which running vacuum cleaner 110 according to the exemplary embodiment approaches an ascending step having a relatively low height. In Specific Example 3, an ascending step having a relatively low height is not a step having a height that cannot be climbed over by a person such as a wall, but is an edge portion of object 200 such as a rug mat or a cushion on which a person can normally ride.

In Specific Example 3, as shown in FIG. 9, vacuum cleaner 110 includes a front downward distance measuring sensor as first sensor 141 on the front surface of the main body of vacuum cleaner 110. The front downward distance measuring sensor is a sensor that measures the distance between the floor surface in front of vacuum cleaner 110 in the running direction and vacuum cleaner 110. Note that the type of front downward distance measuring sensor is not particularly limited, and an infrared distance measuring sensor, a TOF sensor, a camera, a stereo camera, or the like can be exemplified as a front downward distance measuring sensor. However, in order to detect a step ahead in the running direction of vacuum cleaner 110, the sensor used as a front downward distance measuring sensor is preferably a sensor capable of measuring a distance in a range as narrow as possible.

When vacuum cleaner 110 runs on the basis of a running instruction from running controller 101 and approaches an ascending step, first sensor 141 functioning as a front downward distance measuring sensor detects the ascending step in front and outputs information indicating a distance closer than a normal floor. Object detector 107 compares the distance measurement value of first sensor 141 with a predetermined threshold value. When the distance measurement value is less than or equal to the threshold value, object detector 107 determines that the detected object is object 200 on which vacuum cleaner 110 can ride to clean and instructs running controller 101 to execute the operation of making vacuum cleaner 110 ride on the object. In addition, object detector 107 outputs the ascending step as object information together with the coordinates of the edge portion of the ascending step.

In order to change the presentation method in accordance with the physical ability of a target person, object detector 107 may include the height of an ascending step in object information. Danger determination unit 122 may determine danger degree of stumbling or the like in accordance with the depth of the ascending step included in the object information. In addition, object detector 107 may output the position of the edge of the ascending step as coordinates offset to the front side in the running direction of vacuum cleaner 110 with respect to the position acquired by sensing unit 106 as the self-position of vacuum cleaner 110. Note that object detector 107 may set this offset amount on the basis of the distance between the position determined as the self-position of vacuum cleaner 110 and the attachment position of the forward downward distance measuring sensor which is first sensor 141 in the running direction of vacuum cleaner 110.

### Specific Example 4

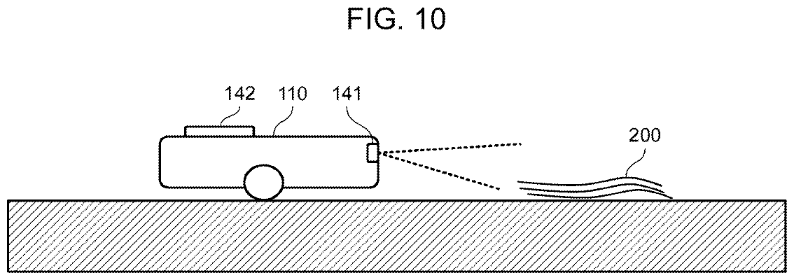

Specific example 4 of generation of object information and determination by danger determination unit 122 based on the object information will be described next with reference to FIG. 10. FIG. 10 is a schematic diagram illustrating a state in which running vacuum cleaner 110 according to the exemplary embodiment approaches object 200 on a floor surface. In Specific Example 4, object 200 is water, oil stain, a kind of paper such as a magazine, flyer, newspaper, a small toy, or the like discarded on the floor surface.

In Specific Example 4, as shown in FIG. 10, vacuum cleaner 110 includes an image sensor as first sensor 141 on the front surface of the main body of vacuum cleaner 110. The image sensor is a sensor that acquires an image of object 200 or the like in front of vacuum cleaner 110 in the running direction. Note that the type of this image sensor is not particularly limited, and a DEPTH camera including an RGB camera, a stereo camera, and a TOF image camera can be exemplified as an image sensor.

When vacuum cleaner 110 runs based on a running instruction from running controller 101 and first sensor 141 functioning as an image sensor captures an image of object 200 in front of vacuum cleaner, sensing unit 106 outputs the captured image of object 200. Object detector 107 processes the image obtained by first sensor 141, specifies the shape, size, type, and the like of object 200 by pattern matching or the like, and causes running controller 101 to execute avoidance running or information acquisition running as necessary. Furthermore, object detector 107 outputs object information including the type, shape, size, and the like of object 200.

Danger determination unit 122 determines the danger degree of object 200 in accordance with the type, size, shape, and the like of object 200 included in the object information. Furthermore, when the image sensor is a DEPTH sensor, object detector 107 may calculate the position of object 200 on the map on the basis of the distance information to object 200 and the self-position of vacuum cleaner 110.

### Specific Example 5

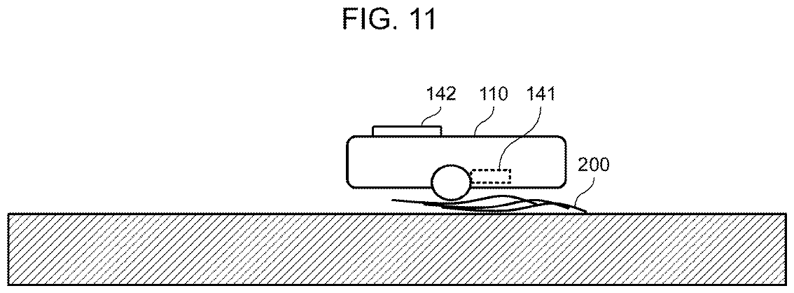

Specific example 5 of generation of object information and determination by danger determination unit 122 based on the object information will be described next with reference to FIG. 11. FIG. 11 is a schematic diagram illustrating a state in which running vacuum cleaner 110 according to the exemplary embodiment rides on object 200 on a floor surface. In Specific Example 5, object 200 is water, oil stain, a kind of paper such as a magazine, flyer, newspaper, a small toy, or the like discarded on the floor surface.

In Specific Example 5, as shown in FIG. 11, vacuum cleaner 110 includes an odometry sensor as first sensor 141 on the front surface of the main body of vacuum cleaner 110. Furthermore, vacuum cleaner 110 includes LiDAR as second sensor 142 in order to acquire the self-position using a method such as triangulation on the basis of the relative angle and distance of the plurality of objects 200 around vacuum cleaner 110 in the running direction of vacuum cleaner 110.

Object detector 107 compares the movement amount calculated from the odometry information acquired from first sensor 141 with the movement amount of the self-position acquired from second sensor 142. Upon determining that the movement amount based on the odometry information is larger than the movement amount of the self-position and the difference is larger than a predetermined movement threshold, object detector 107 determines that the main body of vacuum cleaner 110 is slipping and outputs the difference between the movement amount based on the odometry information and the movement amount of the self-position and the self-position as object information.

When object detector 107 detects a slip, danger determination unit 122 determines the current position of vacuum cleaner 110 as a dangerous position where the target person may slip. In addition, danger determination unit 122 may determine that the danger degree of object 200 is higher as the difference between the movement amount based on the odometry information and the movement amount of the self-position is larger.

As an odometry sensor as first sensor 141, only a sensor that acquires the rotation amount of a drive tire may be adopted. Second sensor 142 is not particularly limited as long as it is a sensor capable of acquiring the movement amount of vacuum cleaner 110, such as a DEPTH camera, in addition to LiDAR. In addition, an odometry sensor connected to a wheel different from the wheel sensed by first sensor 141 may be adopted as second sensor 142.

### Specific Example 6

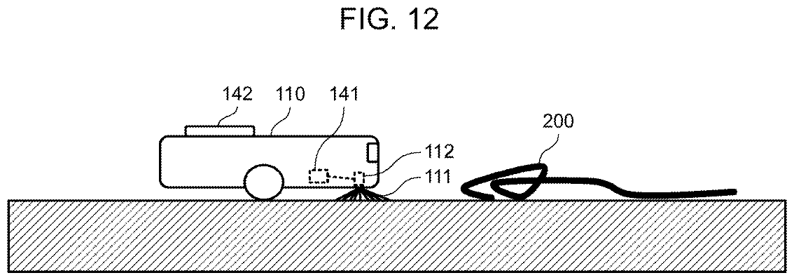

Specific example 6 of generation of object information and determination by danger determination unit 122 based on the object information will be described next with reference to FIG. 12. FIG. 12 is a schematic diagram illustrating a state in which running vacuum cleaner 110 according to the exemplary embodiment approaches string-like object 200 on a floor surface. In Specific Example 6, object 200 is a power cable as wired on the floor surface, an information cable, a string placed on the floor surface, or the like.

In Specific Example 6, as illustrated in FIG. 12, vacuum cleaner 110 includes rotary brush 111 that collects dust on the floor surface toward the suction port and scrapes up the dust in the suction port. Rotary brush 111 is rotationally driven by motor 112. Vacuum cleaner 110 includes a rotation sensor that detects the rotation of motor 112 as first sensor 141.

During cleaning running, string-like object 200 may wind around rotary brush 111 of vacuum cleaner 110, and the rotation of rotary brush 111 may stop. When the rotation of rotary brush 111 stops, sensing unit 106 detects the stop based on first sensor 141. Vacuum cleaner 110 interrupts the cleaning running and cleaning based on the stop of rotary brush 111, and notifies the user of the interruption. Upon detecting the presence of string-like object 200, object detector 107 outputs the fact that detected object 200 is a string-like object and the position of the object as object information.

Danger determination unit 122 determines the position of string-like object 200 as a dangerous position where the target person is likely to stumble.

As described above, vacuum cleaner system 100 according to the present exemplary embodiment can determine the danger of the object detected when vacuum cleaner 110 runs, and post the position of the dangerous object as a dangerous spot in the map displayed on display unit 161. Therefore, since the target person can walk while checking the position of the dangerous spot posted on the map displayed on display unit 161, it is possible to prevent danger such as falling in advance.

Note that the present invention is not limited to the above exemplary embodiment. For example, another exemplary embodiment implemented by arbitrarily combining the constituent elements described in the present specification or excluding some of the constituent elements may be an exemplary embodiment of the present invention. The present invention also includes modifications obtained by making various modifications conceivable by those skilled in the art without departing from the spirit of the present invention, that is, the meaning indicated by the wording described in the claims.

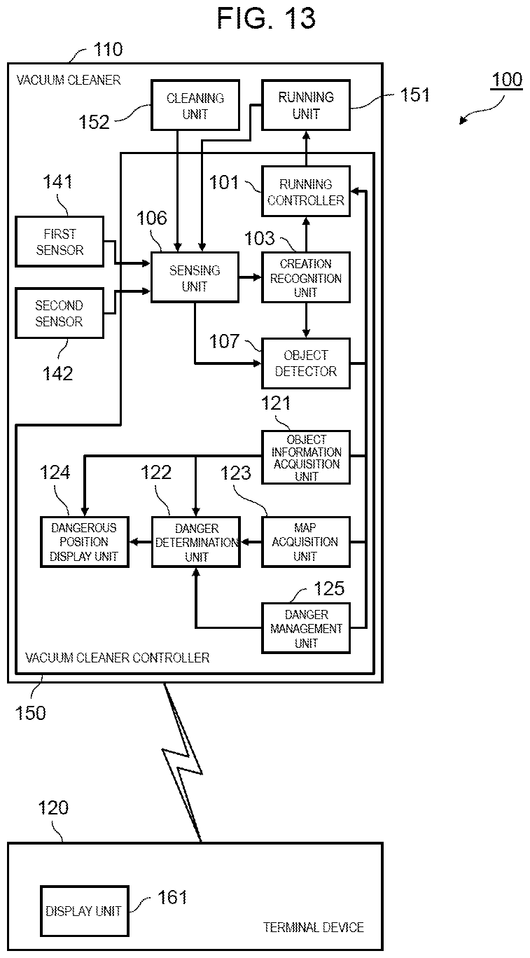

For example, in the above-described exemplary embodiment, the configuration in which each processing unit implemented by executing programs by the processor is divided into autonomous running vacuum cleaner 110 and terminal device 120 has been described. However, which of the processing units is implemented by vacuum cleaner 110 and which is implemented by terminal device 120 is arbitrary. FIG. 13 is a block diagram illustrating a configuration of another example 1 of vacuum cleaner system 100. For example, as illustrated in FIG. 13, the processing units except for display unit 161 may be integrated into vacuum cleaner 110.

FIG. 13 illustrates a configuration in which server 130 does not exist. However, as illustrated in FIG. 13, each device may be configured such that server 130 does not exist and information is directly exchanged between vacuum cleaner 110 and terminal device 120.

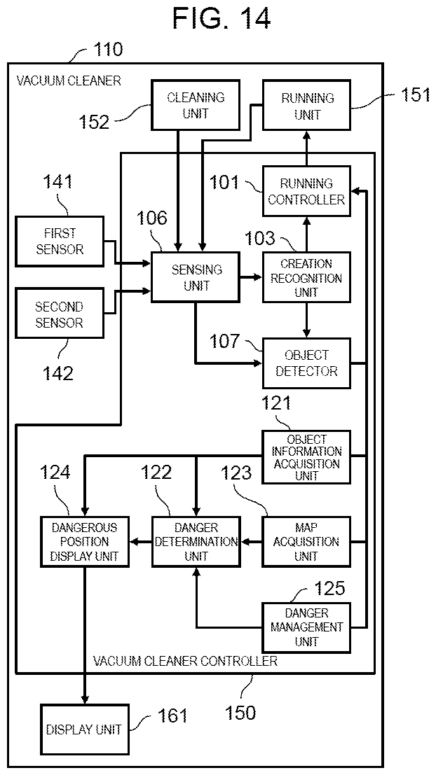

FIG. 14 is a block diagram illustrating a configuration of another example 2 of vacuum cleaner system 100. For example, as illustrated in FIG. 14, vacuum cleaner 110 may include each processing units including display unit 161, and vacuum cleaner 110 alone may constitute vacuum cleaner system 100. In the case of this configuration, vacuum cleaner 110 may be configured to run following the action of a target person when cleaning is not executed, and to notify that the target person has approached the dangerous spot determined during cleaning running.

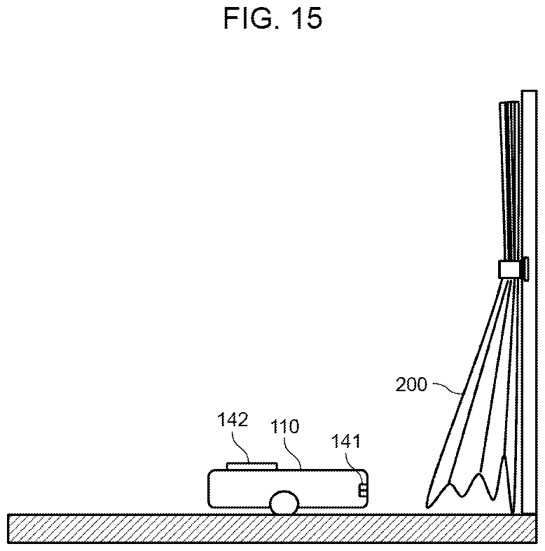

Furthermore, in the above-described exemplary embodiment, the configuration example in which danger determination unit 122 determines an object having danger has been described. However, danger determination unit 122 may be configured to determine an object having low danger as not having a danger. FIG. 15 is a diagram illustrating an example of an object that is not determined to be dangerous. For example, although second sensor 142 such as LiDAR detects that object 200 exists in front of vacuum cleaner 110, sensing unit 106 may not be able to acquire information on the distance corresponding to the object from the ultrasonic sensor functioning as first sensor 141. Such a phenomenon occurs, for example, when object 200 is a soft cloth product such as a curtain or a sofa cover as illustrated in FIG. 15. Whether the object is soft or not cannot be detected by LiDAR. Therefore, when the above phenomenon occurs, danger determination unit 122 may determine that object 200 is a soft cloth product and add information indicating that it is not dangerous to the object information.

Furthermore, danger determination unit 122 may perform image analysis on the basis of the image obtained by a camera, and determine that object 200 existing at a predetermined distance or more above the floor is not dangerous.

Furthermore, target person acquisition unit 126 may estimate the position of a target person. For example, target person acquisition unit 126 may estimate the position of a target person from a camera or the like included in terminal device 120.

The present disclosure is applicable to a vacuum cleaner system that specifies a dangerous place by a running operation of an autonomous running vacuum cleaner and presents the specified dangerous place to a target person.

What is claimed is:

1. A vacuum cleaner system including a vacuum cleaner that performs cleaning while autonomously running and a display unit that displays information acquired from the vacuum cleaner, the system comprising:
an object information acquisition unit that acquires object information based on a sensor included in the vacuum cleaner, the object information being information on an object present around the vacuum cleaner;
a danger determination unit that determines danger of the object based on the acquired object information;
a map acquisition unit that acquires a map of an area where the vacuum cleaner runs; and
a dangerous position display unit that causes the display unit to display the danger of the object determined by the danger determination unit and the acquired position of the object on the map in association with each other.

2. The system according to claim 1, wherein
the vacuum cleaner includes, as the sensor, at least
a first sensor that acquires first object information that is one piece of the object information, and
a second sensor that acquires second object information of a type different from a type of the first object information, and
the danger determination unit determines the danger of the object based on the first object information and the second object information.

3. The system according to claim 1, further comprising an object detector that causes a running controller included in the vacuum cleaner to execute information acquisition running for acquiring the object information.

4. The system according to claim 1, further comprising a danger management unit that acquires danger management information in which a type of the danger and a danger degree that is a degree of the danger are associated with the object information, wherein
the danger determination unit determines the danger of the object based on the acquired danger management information.

5. The system according to claim 4, wherein the dangerous position display unit acquires information on a target person for whom a dangerous position is to be displayed and causes the display unit to display the danger of the object and the acquired position of the object on the map in association with each other in accordance with a type of the target person.

6. A dangerous position posting method in a vacuum cleaner system including a vacuum cleaner that performs cleaning while autonomously running and a display unit that displays information acquired from the vacuum cleaner, the method comprising:
causing an object information acquisition unit to acquire object information from the vacuum cleaner, the object information being information on an object present around the vacuum cleaner;
causing a danger determination unit to determine danger of the object based on the acquired object information;
causing a map acquisition unit to acquire a map of an area where the vacuum cleaner runs; and
causing a dangerous position display unit to cause a display unit to display the danger of the object determined by the danger determination unit and the acquired position of the object on the map in association with each other.
